(19) United States
(12) Patent Application Publication
(10) Pub. No.: US 2013/0249258 A1
(43) Pub. Date: Sep. 26, 2013

(54) SEAT ASSEMBLY HAVING A HEATER WIRE AND A METHOD OF MANUFACTURE

(71) Applicant: LEAR CORPORATION, Southfield, MI (US)

(72) Inventor: Carsten Kortwig, Bischofsheim (DE)

(73) Assignee: LEAR CORPORATION, Southfield, MI (US)

(21) Appl. No.: 13/770,109

(22) Filed: Feb. 19, 2013

(30) Foreign Application Priority Data
Mar. 22, 2012 (DE) 10 2012 204 561.9

(51) Int. Cl. B60N 2/56

(52) U.S. Cl. CPC B60N 2/5685
USPC 297/180.12; 156/73.2

(57) ABSTRACT

A seat assembly having a heater wire and a method of manufacture. The heater wire is made of an electrically conductive material and may be ultrasonically welded to a substrate, such as a trim cover assembly or a seat cushion.

### CROSS-REFERENCE TO RELATED APPLICATIONS

This application claims foreign priority benefits under 35 U.S.C. §119(a)-(d) to DE 10 2012 204 561.9, filed Mar. 22, 2012, the disclosure of which is hereby incorporated by reference in its entirety.

### TECHNICAL FIELD

The present application relates to a seat assembly having a heater wire and a method of manufacture.

### BACKGROUND

A heated seat is disclosed in U.S. Patent Publication No. 2011/0226751.

### SUMMARY

In at least one embodiment, a method of manufacturing a seat assembly is provided. The method may include providing a substrate, positioning a heater wire on a surface of the substrate, and ultrasonically welding the heater wire to the substrate.

In at least one embodiment, a seat assembly is provided. The seat assembly may include a cushion, a trim cover assembly, and a heater wire. The trim cover assembly may be disposed on the cushion. The heater wire may be made of an electrically conductive material and may be disposed directly on the trim cover assembly and/or the cushion.

### BRIEF DESCRIPTION OF THE DRAWINGS

FIG. 1 is a perspective view of an exemplary vehicle seat assembly.

FIG. 2 is a perspective view of an ultrasonic welding apparatus and a substrate having a heater wire that may be provided with the seat assembly.

FIGS. 3 through 12 are side section views of exemplary embodiments of a portion of a seat assembly having a heater wire.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

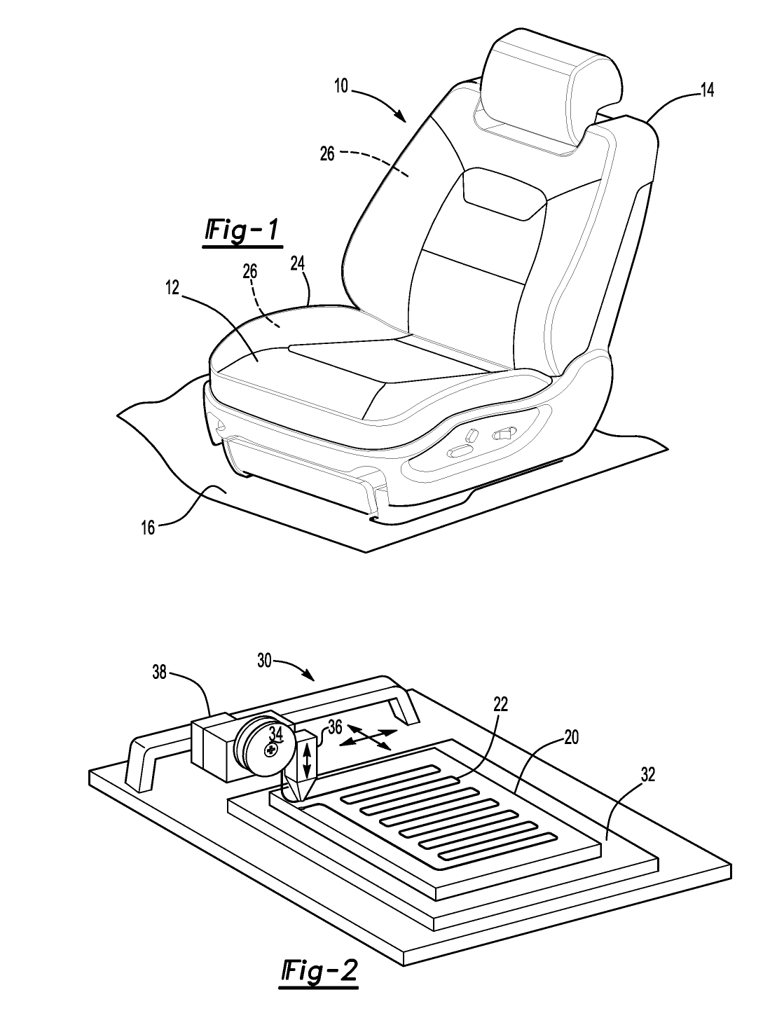

Referring to FIG. 1, an exemplary seat assembly 10 is shown. The seat assembly 10 may be configured for use in a vehicle, such as a motor vehicle like a car or truck. The seat assembly 10 may include a seat bottom 12 and a seat back 14 that may be pivotally disposed on the seat bottom 12. The seat bottom 12 may be configured to be mounted to a surface 16, such as a vehicle floor.

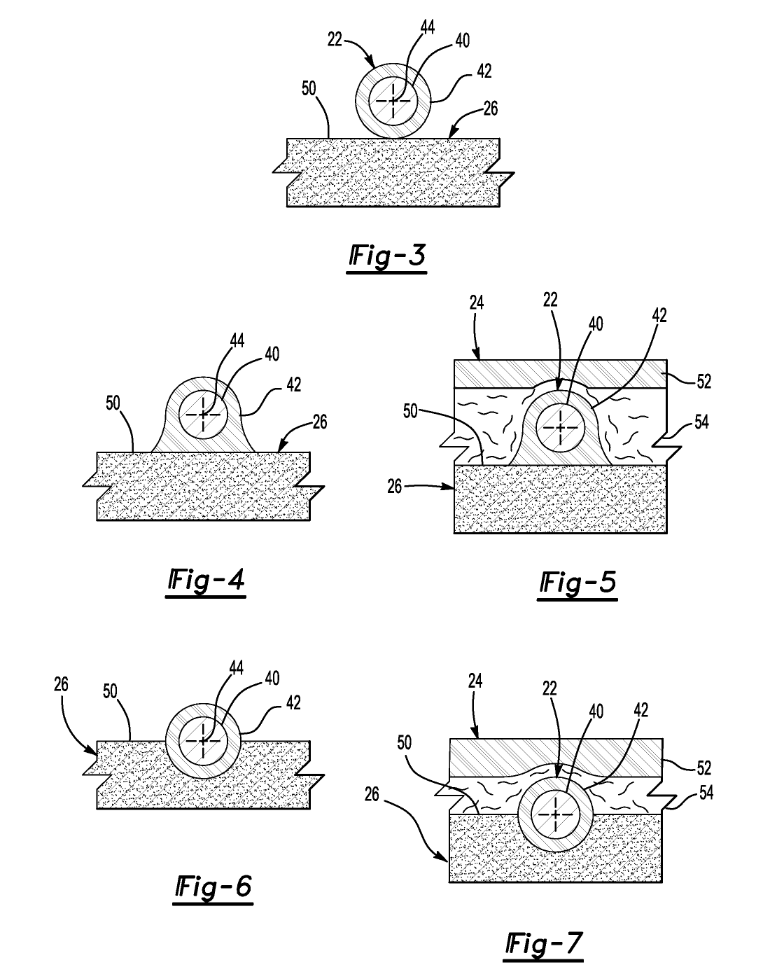

Referring to FIGS. 1 and 2, the seat bottom 12 and/or seat back 14 may include a substrate 20 that receives a heater wire 22 that may be used to heat a portion of the seat assembly 10 and a seat occupant. The substrate 20 may be a trim cover assembly 24 and/or a cushion 26 that may be provided with the seat bottom 12 and/or seat back 14. The trim cover assembly 24 may provide at least a portion of an exterior seating surface of the seat assembly 10. The trim cover assembly 26 may include one or more trim panels that may be made of any suitable material, such as fabric, leather, vinyl, or combinations thereof. The cushion 26 may be disposed under and may engage the trim cover assembly 24. The cushion 26 may be made of any suitable material such as foam.

The heater wire 22 may be positioned on a surface of the substrate 20 with an ultrasonic welding apparatus 30. In at least one embodiment, the ultrasonic welding apparatus 30 may include a table 32, a heater wire source 34, an ultrasonic welding head 36, and at least one actuator 38.

The table 32 may support the substrate 20 and may include a device like as a fixture or clamp for holding the substrate in a desired position.

The heater wire source 34 may be configured to provide the heater wire 22 to the ultrasonic welding head 36. In at least one exemplary embodiment, the heater wire source 34 may be a reel or spool that is configured to rotate about an axis of rotation to feed the heater wire 22 to the ultrasonic welding head 36. In at least one embodiment, the heater wire source 34 may be disposed proximate the ultrasonic welding head 36.

The ultrasonic welding head 36 may be configured to ultrasonically weld the heater wire 22 to the substrate 20. More specifically, the ultrasonic welding head 36 may provide or produce high-frequency ultrasonic acoustic vibrations that may produce localized heating for welding the heater wire 22 to the substrate 20. As such, the heater wire 22 may be welded to the substrate 20 without providing an electrical current through the heater wire 22. The heater wire 22 may be ultrasonically welded to the substrate 20 in a continuous or discontinuous manner. More specifically, the heater wire 22 may be continuously welded to the substrate 20 wherever the heater wire 22 engages the substrate 20 or may be discontinuously welded to the substrate 20 at discrete, spaced apart positions such that ultrasonic welds are absent in at least one position where the heater wire 22 engages the substrate 20, such as between sequential ultrasonic welds. In addition, the ultrasonic welding head 36 may position and exert pressure on the heater wire 22. This pressure may affect the location or penetration depth of the heater wire 22 with respect to substrate 20 and/or the ultrasonic weld location as will be discussed in more detail below.

One or more actuators 38 may be configured to move the table 32 and/or the ultrasonic welding head 36. The actuator 38 may be of any suitable type, such as a mechanical, electromechanical, electrical, pneumatic, or hydraulic actuator. In at least one embodiment, one or more actuators 38 may be used to move the table 32 and/or the ultrasonic welding head 36 along one or more axes, such as orthogonal X-Y-Z axes. The actuators 38 may be controlled by a controller or may be part of a computer numerical control (CNC) system that may be used to move the table 32 and/or ultrasonically welding head 36 along a predetermined path to position the heater wire 22 on the substrate 20 in a predetermined pattern or configuration. For example, the actuator 38 and ultrasonic welding head 36 may cooperate to position the heater wire 22 on the substrate 20 in a serpentine or zigzag pattern in which the heater wire 22 extends back and forth across the surface of the substrate 20. Opposing ends of the heater wire 22 may be positioned near each other to facilitate coupling to an electrical connector which may facilitate coupling to an electrical power source that may provide current that may be used to heat the heater wire 22.

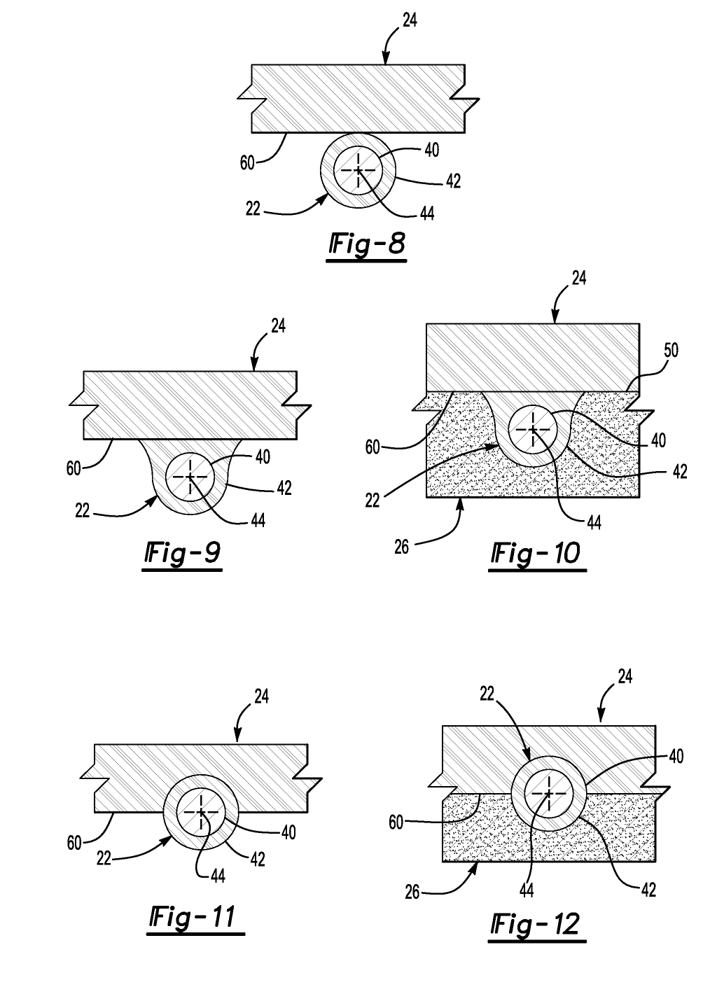

Referring to FIGS. 2 and 3, the heater wire 22 may be provided in various configurations. In at least one embodiment, the heater wire 22 may include a wire portion 40 and a coating 42.

The wire portion 40 may be made of an electrically conductive material, such as a metal or metal alloy like stainless steel or a copper alloy. The wire portion 40 may have any suitable configuration, such as a flat or ribbon configuration that may have a generally rectangular cross section or a substantially circular cross section as shown in FIG. 3. In addition, the wire portion 40 may be disposed along or extend along a center axis 44.

The coating 42, if provided, may be disposed around and may engage an exterior surface of the wire portion 40. The coating 42 may be made of a material that may be an electrical insulator and/or that may be ultrasonically welded to the substrate 20. For example, the coating 42 may be a varnish, lacquer, or a polymeric material and may extend continuously around the wire portion 40 in one or more embodiments. If the coating 42 is omitted, then the wire portion 40 may engage and may be ultrasonically welded to the substrate 20.

Referring to FIGS. 3-12, various section views that help illustrate a method of making a seat assembly 10 having a heater wire 22 disposed on a substrate 20 are shown. These figures show a heater wire 22 having a coating 42 and a wire portion 40 having a substantially circular cross section, but it is to be understood that heater wires having other cross sections or that do not have a coating 42 may be employed. In FIGS. 4-7, the substrate 20 upon which the heater wire 22 is provided is a cushion 26. In FIGS. 8-12, the substrate 20 is a trim cover assembly 24.

Referring to FIGS. 3-6, an exemplary sequence of method steps is shown.

First, the heater wire 22 may be positioned on a surface 50 of the cushion 26 as illustrated in FIG. 3. As such, the center axis 44 of the wire portion 40 may be disposed above the surface 50.

Second, the heater wire 22 may be ultrasonically welded to the surface 50 as shown in FIG. 4. Ultrasonic welding may at least partially melt the coating 42, thereby increasing the coating surface area that is in contact with the surface 50 and bonding the coating 42 to the surface 50. In this embodiment, the heater wire 22 is ultrasonically welded such that the heater wire 22 is disposed on and does not substantially deform or penetrate the surface 50.

Third, the trim cover assembly 24 may be installed over the cushion 26 and the heater wire 22 as shown in FIG. 5. Positioning of the trim cover assembly 24 may be preceded by positioning the cushion 26 on the seat bottom 12 or the seat back 14. The trim cover assembly 24 may include a single layer that engages the cushion 26 and the heater wire 22 or multiple layers, such as a first layer 52 and a second layer 54. The second layer 54, which may be made of a compressible material such as felt or foam, may engage the cushion 26 and the heater wire 22 and may be compressed near the heater wire 22 to reduce deformation of the first layer 52.

Referring to FIGS. 6 and 7, another embodiment of a seat assembly 10 having a heater wire 22 disposed on a cushion 26 is shown. In this embodiment, additional force is exerted upon the heater wire 22 during ultrasonic welding, which causes the heater wire 22 to penetrate the cushion 26 or deform the surface 50 such that the heater wire 22 is at least partially inserted into the cushion 26 as shown in FIG. 6. The additional force may result in the center axis 44 being aligned with or positioned below the surface 50 after ultrasonic welding, which may increase the surface area that engages or that is ultrasonic welded to the cushion 26 and may help reduce the distance by which the heater wire 22 extends from the surface 50. The cushion 26 may be positioned or installed on the seat bottom 12 or the seat back 14 and the trim cover assembly 24 may then be installed over the cushion 26 and the heater wire 22 as shown in FIG. 7. Again the trim cover assembly 24 may include a single layer or multiple layers, such as a first layer 52 and a second layer 54. The second layer 54 may engage the cushion 26 but may be compressed near the heater wire 22 by a lesser amount than the embodiment shown in FIG. 5 due to positioning of the heater wire 22 within the cushion 26.

Referring to FIGS. 8-10, another exemplary sequence of method steps is shown. First, the heater wire 22 may be positioned on a surface 60 of the trim cover assembly 24 as illustrated in FIG. 8. As such, the center axis 44 of the wire portion 40 may not penetrate the surface 60. The trim cover assembly 24 may include a single layer or multiple layers as previously described.

Second, the heater wire 22 may be ultrasonically welded to the surface 60 as shown in FIG. 9. Ultrasonic welding may at least partially melt the coating 42, thereby increasing the coating surface area that is in contact with the surface 60 and bonding the coating 42 to the surface 60. In this embodiment, the heater wire 22 is ultrasonically welded such that the heater wire 22 is disposed on and does not substantially deform or penetrate the surface 60.

Third, the trim cover assembly 24 may be installed over the cushion 26 as shown in FIG. 10. Positioning of the trim cover assembly 24 may be preceded by positioning the cushion 26 on the seat bottom 12 or the seat back 14. Installation of the trim cover assembly 24 may cause the heater wire 22 to deform or penetrate the surface 50 of the cushion 26.

Referring to FIGS. 11 and 12, another embodiment of a seat assembly 10 having a heater wire 22 disposed on a trim cover assembly 24 is shown. In this embodiment, additional force is exerted upon the heater wire 22 during ultrasonic welding, which causes the heater wire 22 to penetrate the trim cover assembly 24 or deform the surface 60 such that the heater wire 22 is at least partially inserted into the trim cover assembly 24 as shown in FIG. 11. The additional force may result in the center axis 44 being aligned with or positioned below the surface 60 after ultrasonic welding, which may increase the surface area that engages or that is ultrasonic welded to the trim cover assembly 24 and may help reduce the distance by which the heater wire 22 extends from the surface 60. The cushion 26 may be positioned or installed on the seat bottom 12 or the seat back 14 and the trim cover assembly 24 may then be installed over the cushion 26 as shown in FIG. 12.

Ultrasonic welding of a heater wire 22 directly to a substrate 20 configured as a trim cover assembly 24 or cushion 26 may replace a laminated heater pad assembly that is provided as a separate component and installed between a cushion and a trim cover, thereby reducing manufacturing steps, material requirements, and associated costs. For instance, a laminated heater pad assembly that is manufactured a separate component may include a heating element that is sandwiched between layers of the heater pad assembly. Such a laminated heater pad assembly employs more layers, material, and manufacturing steps than the ultrasonically welded embodiments described herein. In addition, a laminated heater pad assembly must be installed in a seat assembly. As such, the laminated heater pad assembly may be mispositioned, folded, or damaged during assembly or may move after installation, thereby resulting in degraded or inadequate heating performance or may utilize additional fasteners, stitching, or adhesives to secure the laminated heater pad assembly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of manufacturing a seat assembly comprising:
providing a substrate;
positioning a heater wire on a surface of the substrate; and
ultrasonically welding the heater wire to the substrate.

2. The method of claim 1 wherein the substrate is a cushion that is configured to be covered by a trim cover assembly.

3. The method of claim 1 wherein the substrate is a trim cover assembly that is configured to at least partially cover a cushion.

4. The method of claim 1 wherein the step of positioning the heater wire includes providing a heater wire source, feeding the heater wire from the heater wire source to an ultrasonic welding head, and moving the ultrasonic welding head along a predetermined path, wherein the heater wire is positioned on the surface of the substrate when the ultrasonic welding head is moved along the predetermined path.

5. The method of claim 4 wherein the step of ultrasonically welding the heater wire includes ultrasonically welding the heater wire to the substrate with the ultrasonic welding head at multiple spaced apart positions along the predetermined path.

6. The method of claim 4 wherein the step of ultrasonically welding the heater wire includes ultrasonically welding the heater wire to the substrate with the ultrasonic welding head continuously along the predetermined path.

7. The method of claim 1 wherein the step of positioning the heater wire includes providing a heater wire source, feeding the heater wire from the heater wire source to an ultrasonic welding head, and moving the substrate with respect to the ultrasonic welding head to position the heater wire along a predetermined path.

8. The method of claim 7 wherein the step of ultrasonically welding the heater wire includes ultrasonically welding the heater wire to the substrate with the ultrasonic welding head at multiple spaced apart positions.

9. The method of claim 7 wherein the step of ultrasonically welding the heater wire includes ultrasonically welding the heater wire to the substrate with the ultrasonic welding head continuously along the predetermined path.

10. A method of manufacturing a seat assembly comprising:
providing a cushion;
positioning a heater wire into engagement with the cushion; and
ultrasonically welding the heater wire to the cushion.

11. The method of claim 10 wherein the heater wire includes a wire portion and a coating disposed on the wire portion, wherein ultrasonically welding the heater wire at least partially melts the coating such that the coating is welded to the cushion.

12. The method of claim 11 wherein the heater wire is disposed completely above a surface of the cushion after the heater wire is ultrasonically welded to the cushion.

13. The method of claim 11 wherein force is exerted on the heater wire during ultrasonic welding such that the heater wire penetrates a surface of the cushion.

14. The method of claim 11 further comprising positioning a trim cover assembly over the cushion such that the heater wire engages the trim cover assembly.

15. The method of claim 10 wherein the heater wire includes a center axis and wherein the center axis is positioned above a surface of the cushion when the heater wire is positioned into engagement with the cushion and the center axis is positioned below a surface of the cushion after the heater wire is ultrasonically welded to the cushion.

16. The method of claim 10 wherein the heater wire is ultrasonically welded to the cushion along its entire length.

17. The method of claim 10 wherein the heater wire is ultrasonically welded to the cushion at discrete positions that are spaced apart from each other.

18. A seat assembly comprising:
a cushion;
a trim cover assembly disposed on the cushion; and
a heater wire that is made of an electrically conductive material and that is disposed in direct engagement and attached to the trim cover assembly and/or the cushion.

19. The seat assembly of claim 18 wherein the heater wire is an uncoated electrically conductive wire that engages and is ultrasonically welded to at least one of the trim cover assembly and the cushion.

20. The seat assembly of claim 18 wherein the heater wire includes a wire portion and a coating disposed on and around the wire portion, wherein the coating engages and is ultrasonically welded to at least one of the trim cover assembly and the cushion.
